(19) United States
(12) Patent Application Publication
(10) Pub. No.: US 2015/0025899 A1
(43) Pub. Date: Jan. 22, 2015

(54) METHOD OF IMPROVING PATIENT ACCESS TO HEALTHCARE SERVICES

(71) Applicants: David A. Kleiman, Arlington, TX (US); Anthony W. Evangelista, Arlington, TX (US)

(72) Inventors: David A. Kleiman, Arlington, TX (US); Anthony W. Evangelista, Arlington, TX (US)

(21) Appl. No.: 13/945,964

(22) Filed: Jul. 19, 2013

(51) Int. Cl. G06F 19/00

(52) U.S. Cl. CPC G06F 19/3425
USPC 705/2

(57) ABSTRACT

In accordance with one embodiment, a method is provided for improving patient recruitment by obtaining a lead that was exposed to at least one message through a referral channel, identifying the lead's contact information and the referral channel the lead was obtained through and storing it in a memory, and tracking the lead to determine if the lead becomes a patient. In one particular embodiment, the referral channel may comprise print, radio, television, or web-based advertising. In another embodiment, the referral channel may be a co-managing provider. In some embodiments, the present invention further comprises splitting a fee, which was incurred by the patient, with the co-managing provider based on the service performed by the co-managing provider; and establishing a relationship with a co-managing provider by referring a patient to the co-managing provider to have a healthcare service performed.

### TECHNICAL FIELD

This invention relates in general to the field of medical software, and more particularly to a method of improving patient access to healthcare services.

### BACKGROUND OF THE INVENTION

Providing high-quality medical services requires, among others, hiring highly trained, quality medical staff, obtaining sophisticated medical equipment and devices, developing rigorous sanitization procedures to maintain sterile environments, and maintaining a high level of communication and responsiveness to patient needs. Such requirements are necessarily costly and difficult to sustain. At the end of the day, medical practices are businesses whose financial success is closely tied to the quality of care they are able to offer their patients. Thus, improving patient care is often dependent on developing more efficient business practices.

One problem with existing methods of managing patient care is that information systems often do not adequately monitor a patient's status as it develops or do not require medical service providers to diligently follow-up with the patient to determine obstacles to treatment and to develop a workaround plan. As a result, the patient may fail to obtain a necessary or desired treatment because of problems with scheduling, financing, or means of access to the medical service.

Inefficient business practices can also lead to a reduced pool of resources that can be applied to patient services. With current methods of developing new patient relationships, the effective reach of a medical practice may be limited to a particular geographic area because of the distance patients are willing or able to travel to receive a treatment.

Medical service providers rely on referrals from other providers as well as local advertising on radio and television to attract new patients. However, existing methods of maintaining patient records do not adequately track how a patient was acquired or referred to the practice. Furthermore, patient information must be recorded more than once because existing patient management systems do not electronically interface with referral data sources. Hence, staff time may be wasted, and financial investments in advertising or time spent maintaining relationships with other providers may be inefficiently distributed.

Another problem afflicting existing healthcare management systems is the difficulty in incentivizing consultation specialists and accounts receivable managers to convert referrals and receivables into revenue. The opaque and uncertain nature of reward structures does not achieve maximal incentive potential.

### BRIEF SUMMARY OF THE INVENTION

In accordance with one aspect of the present invention, a method of improving patient access to healthcare services is provided which substantially eliminates or reduces disadvantages associated with previous methods.

In accordance with one embodiment, a method is provided for improving patient recruitment by obtaining a lead that was exposed to at least one message through a referral channel, identifying the lead's contact information and the referral channel the lead was obtained through and storing it in a memory, and tracking the lead to determine if the lead becomes a patient. In one particular embodiment, the referral channel may comprise print, radio, television, or web-based advertising. In another embodiment, the referral channel may be a co-managing provider. In some embodiments, the present invention further comprises splitting a fee, which was incurred by the patient, with the co-managing provider based on the service performed by the co-managing provider; and establishing a relationship with a co-managing provider by referring a patient to the co-managing provider to have a healthcare service performed.

### BRIEF DESCRIPTION OF THE FIGURES

For a more complete understanding of the present invention and its advantages, reference is now made to the following description and the accompanying drawings, in which:

FIG. 1A illustrates a method of co-managing patient care in accordance with one embodiment of the present invention;

FIG. 1B illustrates a method of tracking the development of a patient's diagnosis and treatment in accordance with another embodiment;

FIG. 2 illustrates a method of identifying a provider of healthcare services to help co-manage patient care in accordance with another embodiment;

FIG. 3 illustrates an embodiment wherein a method of evaluating the effectiveness of investment allocations in advertising healthcare services is disclosed;

FIG. 4 illustrates in another embodiment a method of providing a services provider, who is co-managing patient care, with access to shared patient information and fee splitting information;

FIG. 5 illustrates a method of developing a co-managed care plan in accordance with another embodiment of the present invention;

FIG. 6 illustrates an embodiment in which an interface is presented to a user to facilitate the capture of patient information, including the referral source;

FIG. 7 illustrates a report from one embodiment of the present invention that juxtaposes in detail the cost of advertising investment and the number of patients who have committed to care originating from that advertising source;

FIG. 8 illustrates a method of providing an overview of patient origination and treatment throughput in accordance with another embodiment of the present invention;

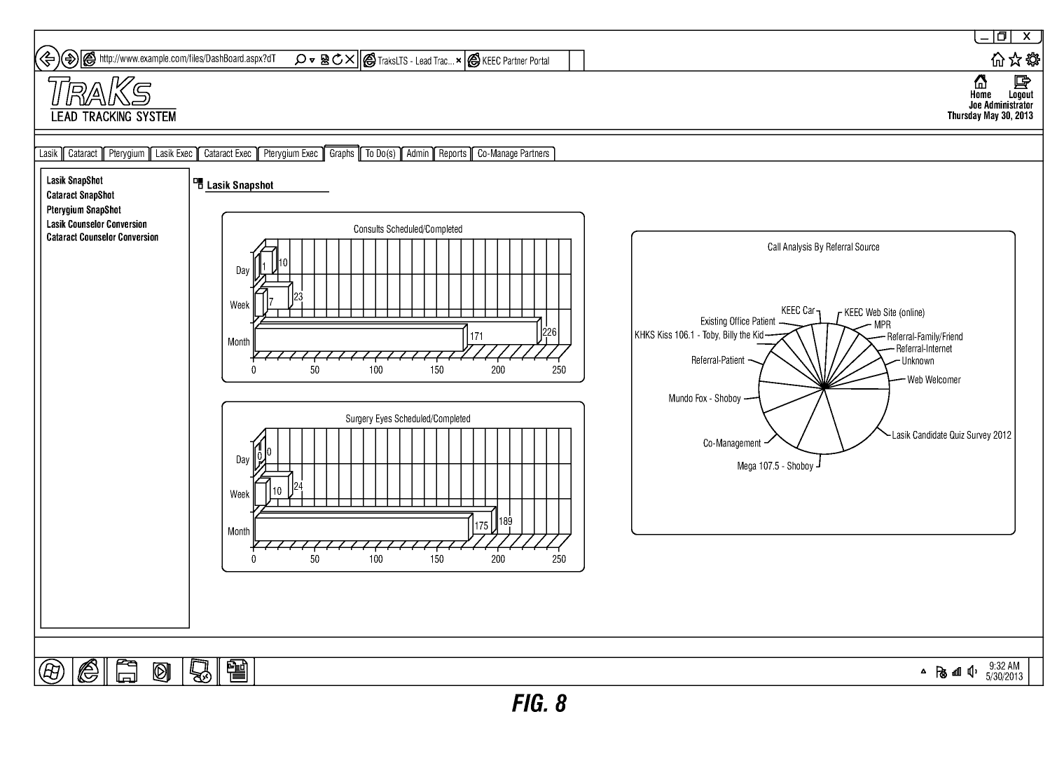

FIG. 9 illustrates a user interface from one embodiment for tracking the status and outcome of patient consultations as well as patient diagnoses;

FIG. 10 illustrates an embodiment in which a portal is made available to service providers to review the status of co-managed patients;

FIG. 11 illustrates a tool for estimating additional revenue available to service providers for referring patients for co-managed care in accordance with another embodiment of the present invention;

FIG. 12 illustrates a method from one embodiment of identifying the optimal service provider to cooperate in providing patient care;

FIG. 13 illustrates an administrative dashboard, capable of being updated in real-time, that provides an overview of current consultation and care operations across multiple locations of a medical practice in accordance with another embodiment;

FIG. 14 illustrates another embodiment in which a view is displayed to a user that details the current status and past history of a patient in the co-managed care workflow; and

FIG. 15 illustrates a report from another embodiment to assist practice administrators in evaluating the effectiveness of patient care counselors in accordance with another embodiment of the present invention.

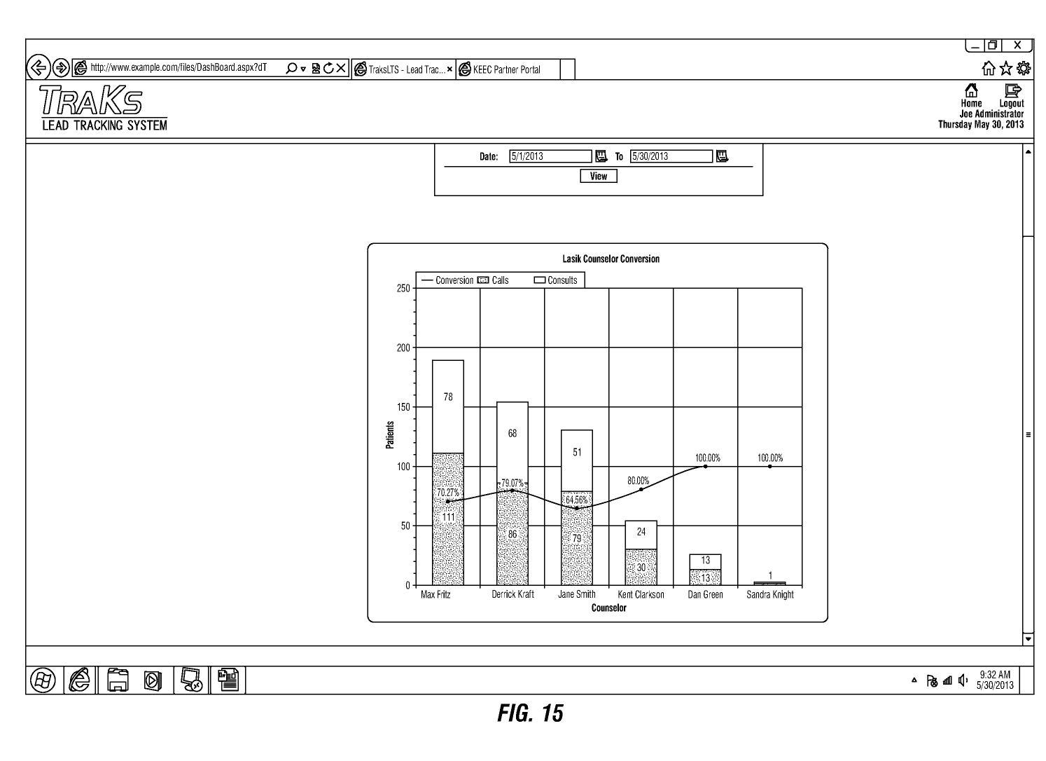

The above figures are provided for the purpose of illustration and description only, and are not intended to define the limits of the disclosed invention. Use of the same reference number in multiple figures is intended to designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the particular embodiment. The extension of the figures with respect to number, position, relationship, and dimensions of the parts to form the preferred embodiment will be explained or will be within the skill of the art after the following teachings of the present invention have been read and understood.

### DETAILED DESCRIPTION

As used herein, the term “co-managing provider” refers to a healthcare provider that cooperates in the treatment of a patient with another healthcare provider by providing at least one consultation, treatment, procedure, or healthcare service. For example, a co-managing provider may be an optician, optometrist, dentist, dental hygienist, doctor, surgeon, plastic surgeon, specialist, nurse, nurse practitioner, psychiatrist, counselor, therapist, physical therapist, dietician, nutritionist, weight-loss management consultant, or any other provider of healthcare services.

As used herein, the term “referral channel” refers to a means through which patients are referred to a practice offering healthcare services. For example, a referral channel may be a friend, a colleague, another patient, a healthcare provider, a hospital, or any other such source. Alternatively, a referral channel may involve exposure to at least one message through an advertising medium such as radio, newspaper, magazine, television, pre-feature movie advertising, web-based advertising, sponsored searches or keywords, social network advertising, mobile advertising, billboards, sponsorships, endorsements, or any other media through which an audience may be exposed to an advertising message.

The system of the present invention can be implemented on a networked computing device platform that is capable of local or remote access by a user. For example, the computing device can be a stored program computer such as a desktop, laptop, server, mainframe, or the like, including but not limited to a RISC or CISC processor, a DSP, a programmable logic device or the like, capable of executing program instructions. Further, it is possible that the system may utilize any one or some combination of the aforementioned devices. Choice of hardware and implementation is considered to be within the skill of one of ordinary skill in the art for which the invention applies.

The process steps of the present invention can be implemented in high or low level programming or scripting languages, such as Basic, C, C++, C#, JavaScript, Java, Ruby, Perl, or the like. Further, some combination of programming utilities may be utilized to achieve the process steps of the invention. Choice of programming language and implementation is considered to be within the skill of one of ordinary skill in the art for which the invention applies. Further, the system may include application programming interface (API) call capabilities to allow a provider or payer to access the novel functionality through use of API calls made within a web browser instance, or may be provided in a proprietary format with a graphical user interface as depicted herein.

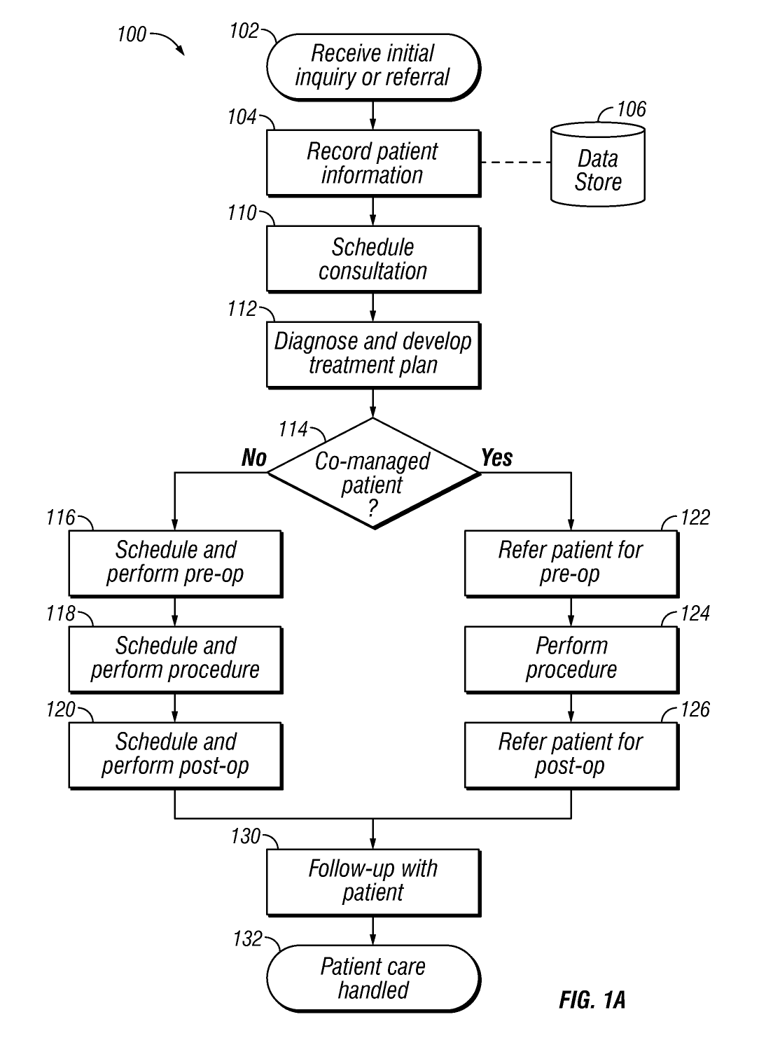

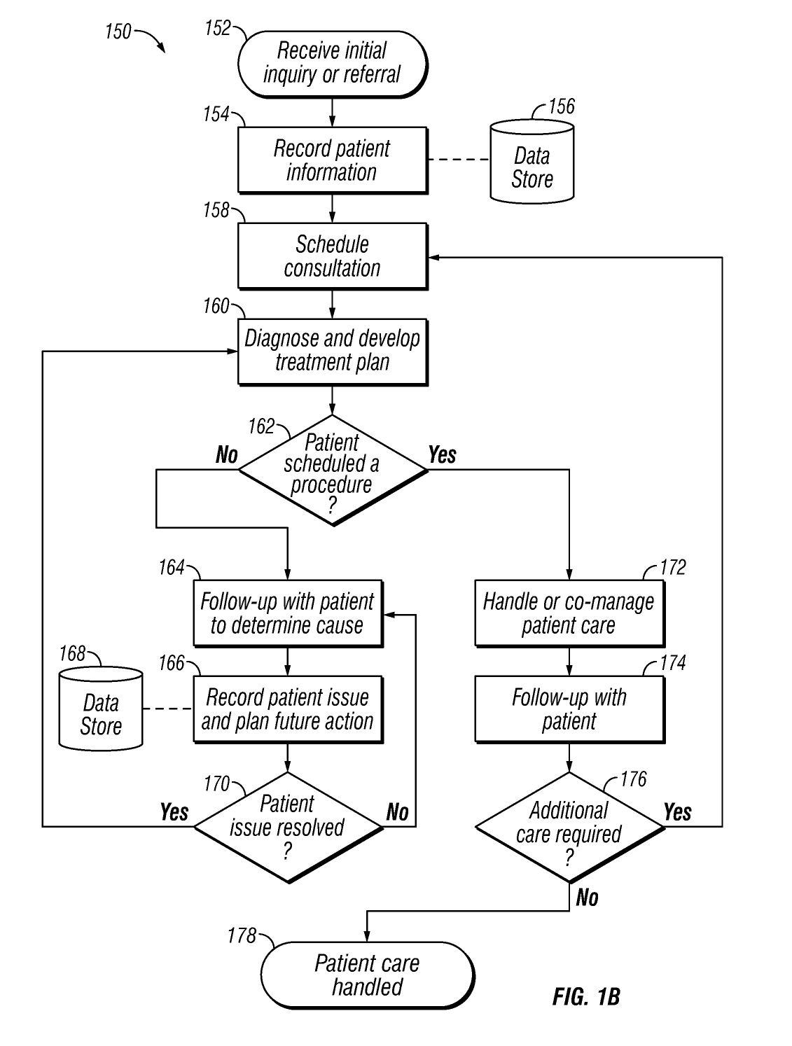

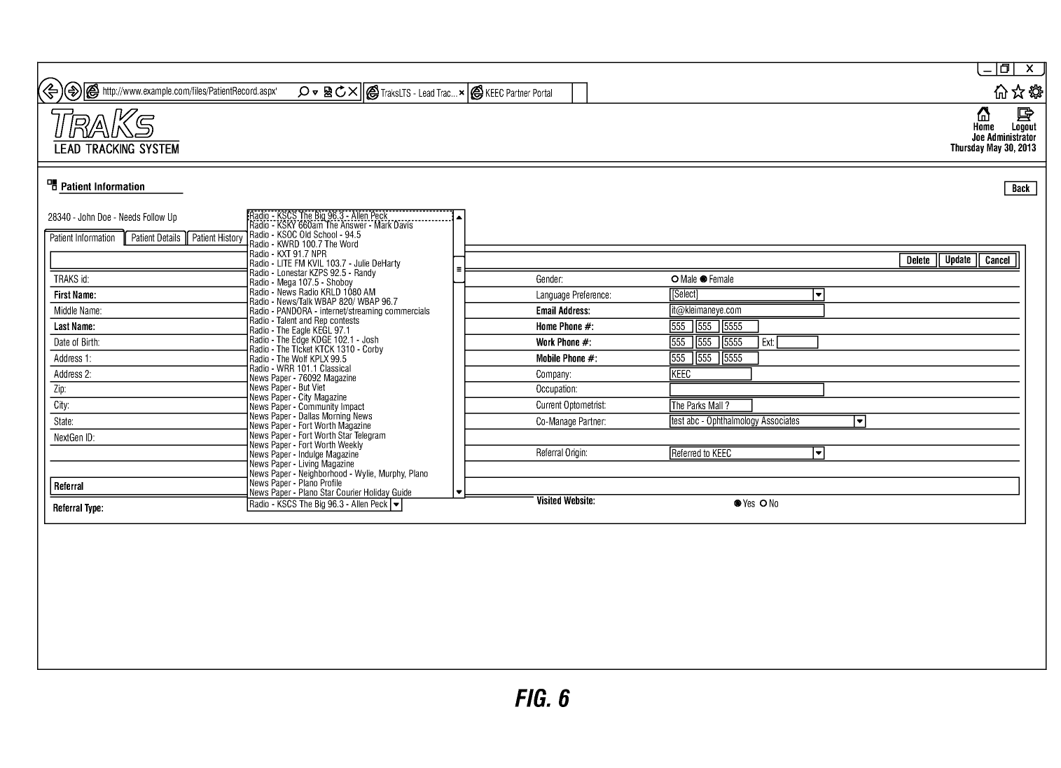

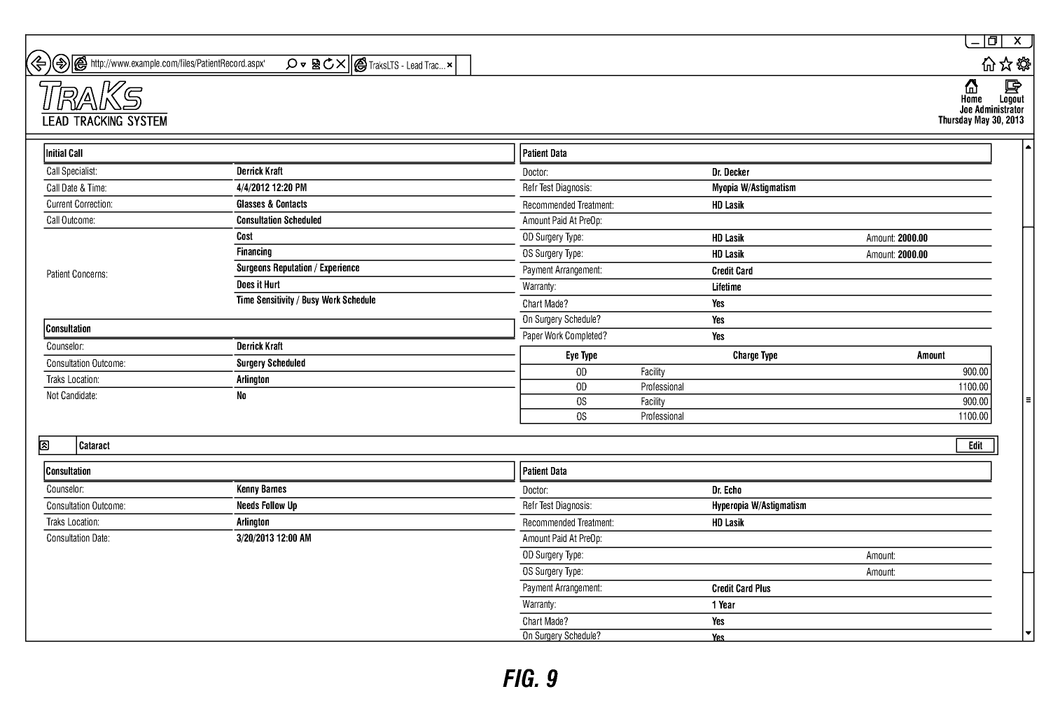

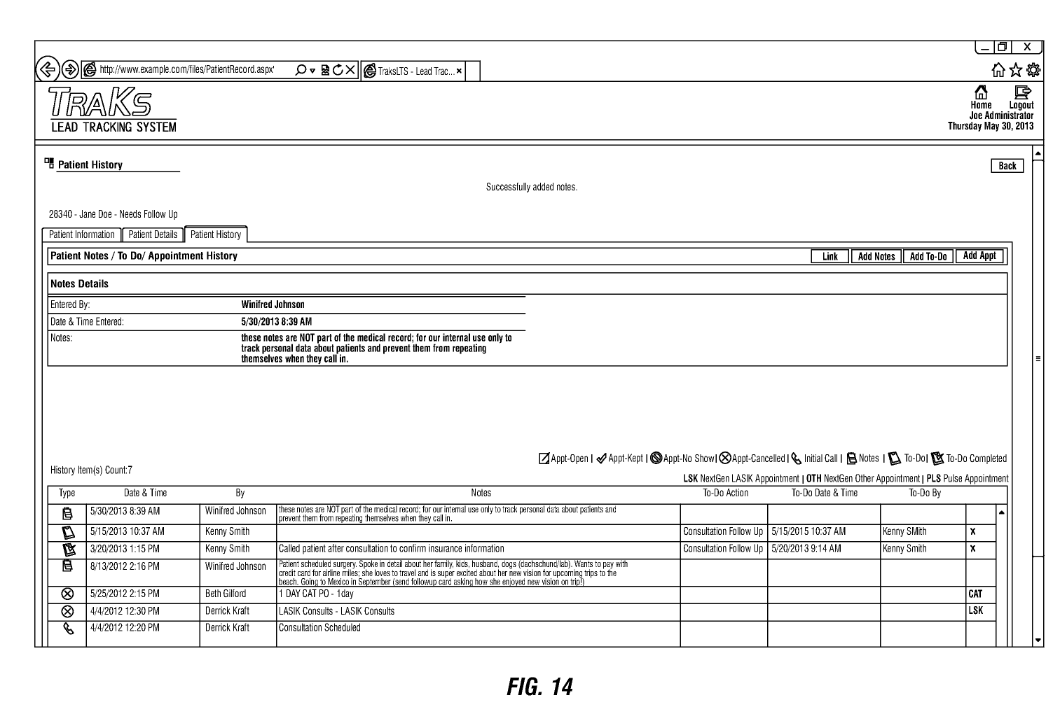

FIG. 1A illustrates a method of co-managing patient care in accordance with one embodiment, indicated generally at 100, that begins with receiving a patient inquiry or referral 102. A patient may discover the medical practice independently or may be alerted to its existence through advertising. A friend or another service provider may also refer a patient. The system captures the patient's information in step 104 and persists the information in a data store 106. The data store 106 may be implemented using any device or service operable to store and retrieve structured data, such as non-volatile flash memory, a hard disk, a flat file, a database, a network file system, network attached storage, a distributed file system, cloud storage, or a web service. In some embodiments, the patient information may share the data store 106 with a medical practice system or patient records system; or, alternatively, the patient information may be replicated or synchronized between the systems. Shared access reduces or eliminates data entry requirements and permits real-time data sharing between systems. The information captured may include the patient's name, gender, birthdate, address, email address, phone numbers, occupation, current doctor, and referral origin. In one particular embodiment, a data entry form may be presented to an operator to capture patient information as illustrated in FIG. 6. In such an embodiment, a predetermined list of referral-origin options may be presented to the operator to select from based on the patient's input. In other embodiments, the information may be automatically parsed from electronic patient records (not depicted) or scanned in from a paper form filled out by the patient and digitized using OCR (not depicted). If the patient information does not already identify a condition the patient is seeking treatment for, a communication with the patient is established to determine the additional information and to identify any concerns that the patient may have about treatment. FIG. 9 illustrates one embodiment in which a patient care specialist calls the patient directly and records patient responses using a data entry screen. In other embodiments, a patient care specialist may communicate with the patient via email, telepresence, instant messaging, or directly in person. In yet another embodiment, the system may contact the patient with an automated message to solicit the patient to electronically submit his or her responses directly via a web-based form, a mobile app, voice response system, or similar method. As part of the communication, a to-do item identifying a next step is determined and added to the patient's workflow, and the date of the communication is recorded. In one embodiment, to-do items can be viewed as part of the patient's history, which is kept separate from the patient's medical records, as illustrated in FIG. 14.

If the patient's condition is treatable by the medical practice, a consultation is scheduled in step 110. The consultation may be conducted in person, by phone, via telepresence, or by any similar means by a general medical practitioner, a medical specialist, or by a trained staff member. Based on information collected from the patient in step 110, a healthcare provider works with the patient to diagnose and develop a treatment plan in step 112 and determines whether the patient's care is to be co-managed in step 114. Some patients may receive co-managed care because they were referred only for a particular operation and prefer to receive pre- and post-treatment from the referring provider. Other patients may receive co-managed care because they reside in a remote location and referring the patient for partial treatment by a local services provider may reduce the number of long-distance trips needed to complete their care. If the patient will not be co-managed, a pre-treatment may be scheduled and performed in step 116. After pre-treatment is received, the patient is scheduled for and provided at least one procedure in step 118, and scheduled for and provided post-treatment in step 120. However, if the patient will be co-managed, the patient may instead be referred to another services provider for pre-treatment. After the patient is pre-treated, at least one procedure is scheduled and performed in step 124. In step 126, the patient is referred to a services provider for post-treatment. A single services provider may offer both pre- and post-treatment. After the patient's treatment is completed, the system schedules follow-up tasks in the patient workflow in step 130 to help ensure that the treatment received was satisfactory, no unexpected complications have developed, and that the patient does not require further services at present, thus concluding the handling of the patient's care at step 132.

FIG. 1B illustrates a method of improving patient access to care, indicated generally at 150, which may help to highlight some of the adaptive aspects of the present invention. The process begins at step 152 with the receipt of an initial patient inquiry or referral. The system records the patient's information in step 154 and persists it in a data store 156. The data store 156 may be implemented using any device or service operable to store and retrieve structured data, such as non-volatile flash memory, a hard disk, a flat file, a database, a network file system, network attached storage, a distributed file system, cloud storage, or a web service. The information captured may include the patient's name, gender, birthdate, address, email address, phone numbers, occupation, current doctor, and referral origin. The patient information may be captured using any means disclosed by other embodiments described herein. After recording the patient's information, a consultation is scheduled in step 158. Based on the consultation, a provider works with the patient in step 160 to diagnose the patient's condition and to develop a treatment plan. Despite a treatment having been recommended in step 160, not all patients follow through by scheduling a procedure. For example, the treatment may not be covered by the patient's current healthcare plan or the patient may not otherwise be able to finance the procedure. The patient may have a scheduling conflict that interferes with at least part of the treatment plan, such as an extended vacation or the patient must return to school. Or, the patient may avoid committing to treatment because the patient has serious concerns about the operation.

If it is determined in step 162 that the patient does not wish to schedule a procedure, the following steps will be taken to overcome any obstacles to patient treatment. As part of step 164, a to-do action is generated by the system and added to the patient's workflow to trigger a later follow-up communication with the patient to determine a cause for not scheduling a procedure. The follow-up communication may be scheduled for a date when the patient is in a better position to consider treatment. For example, the communication may be scheduled for a date after a patient has had the opportunity to change insurance plans or for when a patient returns from a trip overseas. Based on the follow-up communication with the patient in step 164, any lingering patient issues or concerns are recorded in the data store 156 and a future action is planned in step 166. If the patient's issue is resolved 170, then the patient's diagnosis and treatment plan may be reevaluated in step 160.

On the other hand, if the patient schedules a procedure in step 162, then the patient's care is handled directly or in conjunction with a co-managing provider in step 172. After the patient has been treated, a follow-up communication with the patient is conducted in step 174 to determine if the patient is satisfied with treatment and to determine whether additional care is required 176. If additional care is required 176, then the patient workflow returns to step 158 where a new consultation is scheduled. Otherwise, the method concludes when the patient's care has been handled 178.

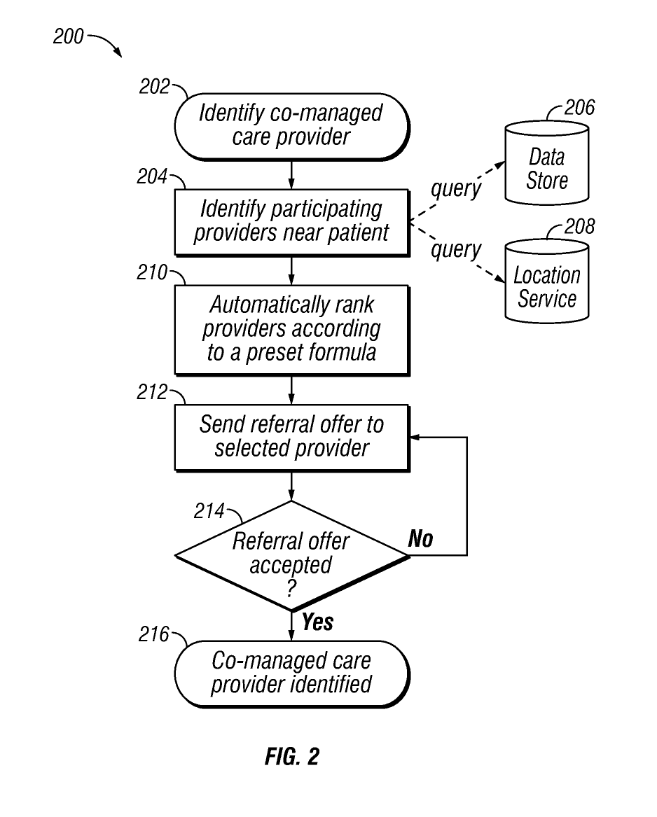

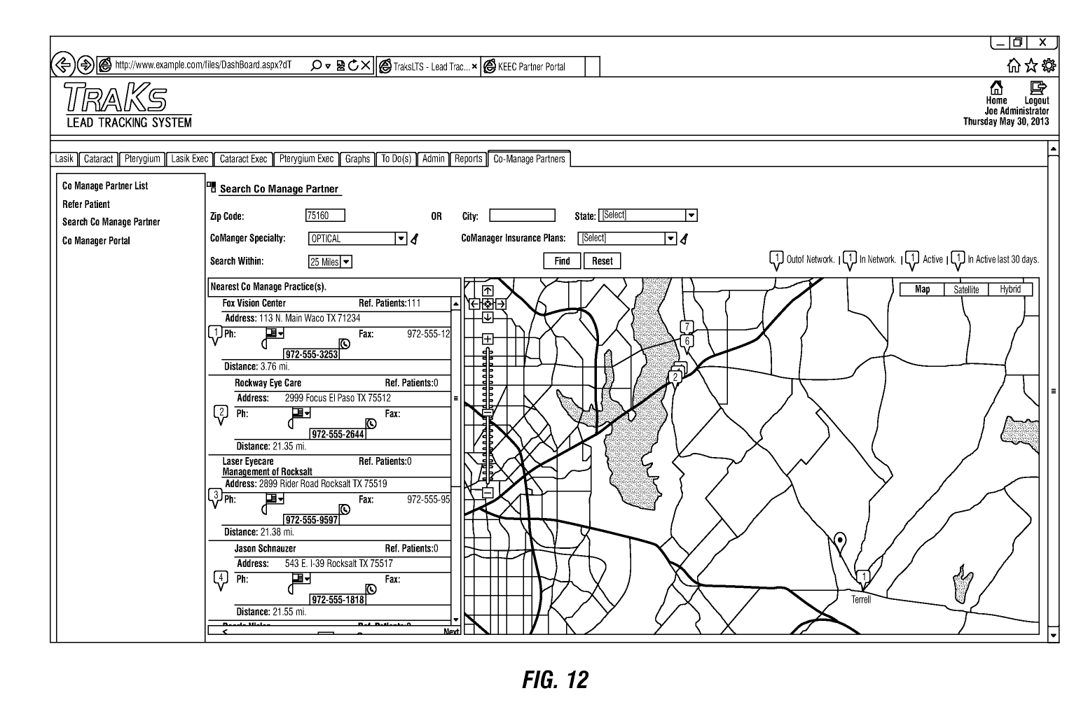

FIG. 2 illustrates a method of identifying a provider of healthcare services to help co-manage patient care, indicated generally at 200, in accordance with another embodiment. Identification of a co-managed care provider begins at step 202. The system identifies co-managing providers near the patient's preferred treatment location in step 204 (often his or her residence) by querying a data store 206 to retrieve locations of co-managing providers and by querying a location service 208 to identify which of those providers fall within a defined proximity of the patient. The data store 206 may be implemented using any device or service operable to store and retrieve structured data, such as non-volatile flash memory, a hard disk, a flat file, a database, a network file system, network attached storage, a distributed file system, cloud storage, or a web service. The location service 208 may be implemented using any service comprising a custom geographic information system, a web mapping service such as Google Maps® or Bing Maps®, or any other suitable service for determining the relative proximity of two physical locations. In one particular embodiment, a search may be performed where the results are filtered according to a co-managing provider's specialty and type of insurance accepted as illustrated by FIG. 12. In step 210, the system automatically ranks the results according to a preset formula. It would be apparent to a person having ordinary skill in the art how to define an algorithm capable of sorting a list according to various weighted factors. However, the following simple formula is provided as an example:

RESULT_SCORE=PROXIMITY*PROXIMITY_WEIGHT+IN_NETWORK_BONUS+NUM_REFERRALS*REFERRAL_WEIGHT.

In certain formulations, the results may be weighted according to the proximity to the patient's preferred treatment location with preference being given to providers that are in network. In other formulations, the results may be weighted according to the number of patients a co-managing provider has referred in the past. In one embodiment, preference may be given to those providers who have not yet referred many patients so as to expand the medical practice's network of co-managing providers. In yet another formulation, the results may be weighted such that co-managing providers who have received positive feedback from patients are given a higher rank than those providers receiving less positive feedback. The search may also take into account the patient's history and concerns when identifying an optimal match for a co-managing provider. At step 212, a user selects a desired co-managing provider from the list of results and makes a referral offer to the provider. In a particular embodiment, the user calls the co-managing provider on the phone to establish an agreement about the referral. In another embodiment, the selection of the co-managing provider may be done through a user interface to trigger the system to send a referral offer to the provider. In some embodiments, the system may select the top co-managing provider automatically according to the preset formula. If the referral offer is not accepted by the selected co-managing provider in step 214, another provider will be selected in 212. Otherwise, identification of a co-managed provider concludes with step 216.

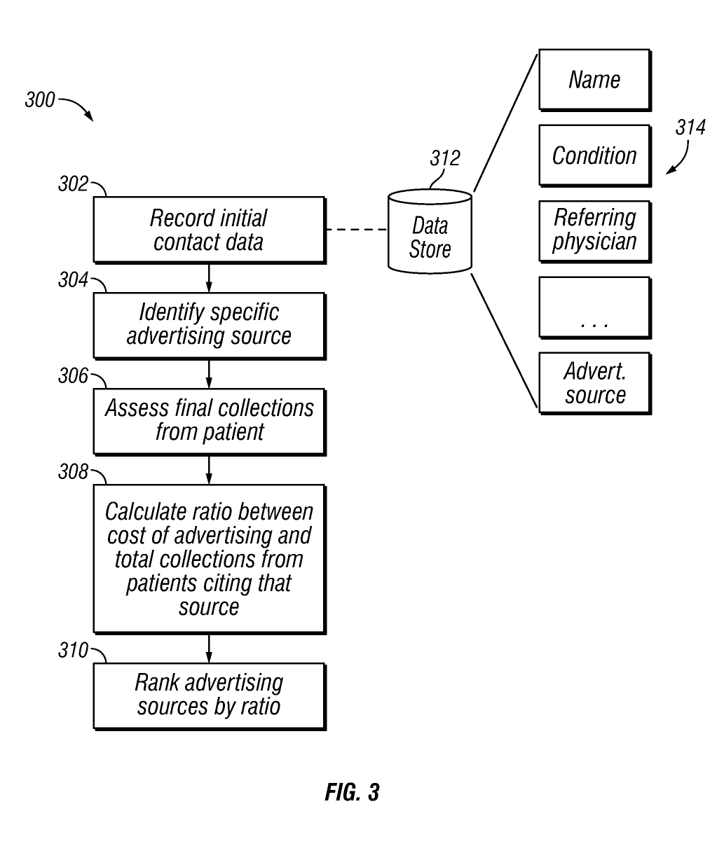

FIG. 3 illustrates a method of evaluating the effectiveness of certain referral investments to attract new patients to a medical practice in accordance with one embodiment. Step 302 begins with recording initial contact data for the lead in a data store 312. The data store 312 may be implemented using any device or service operable to store and retrieve structured data, such as non-volatile flash memory, a hard disk, a flat file, a database, a network file system, network attached storage, a distributed file system, cloud storage, or a web service. In step 304, the lead is queried to determine what referral channel the lead was obtained through. In a particular embodiment, the referral channel may be another healthcare service provider who refers patients to the medical practice. In other embodiments, the referral channel may involve exposure to at least one advertising message through print advertising, radio advertising, television commercials, billboards, pre-feature advertising in theatres, web-based advertising, mobile advertising, or any other form of media suitable to deliver a marketing message. For example, FIG. 6 depicts an embodiment in which a user interface is used to capture the referral source of the lead. The system may also track whether the lead becomes a patient to help assess a medical practice's effectiveness in converting leads to patients. In such an embodiment, the system may keep a history of communications with such an individual to facilitate the tracking of his or her evolving financial or medical status.

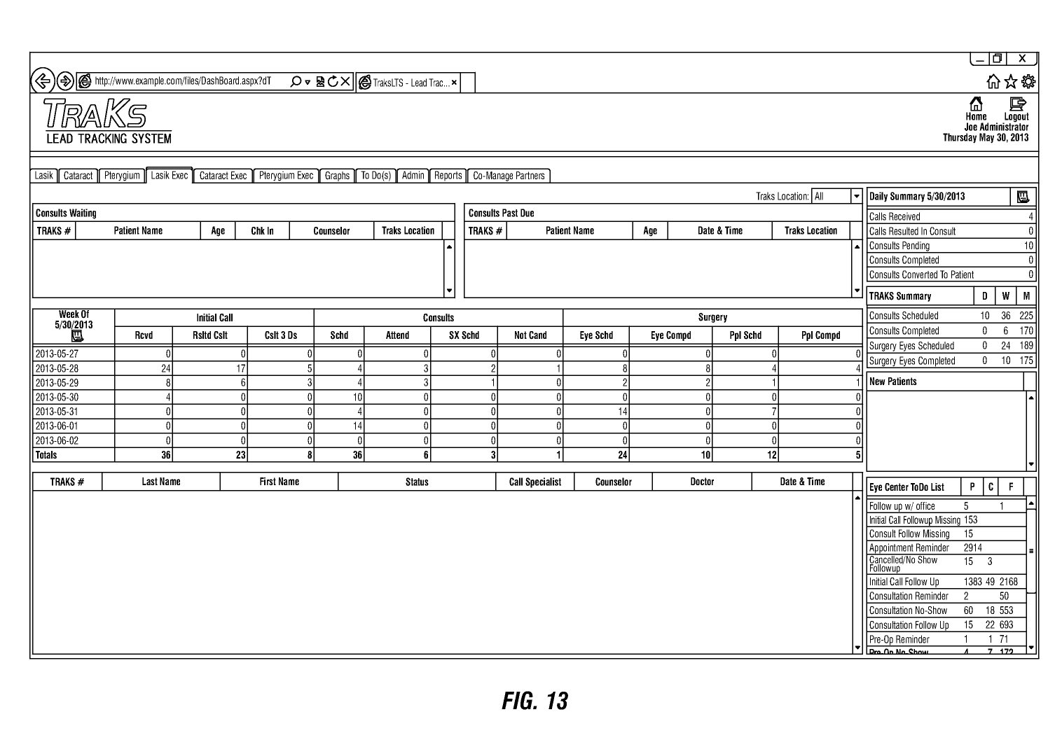

FIG. 14 illustrates an interface from one embodiment where the lead is tracked using a workflow. To-dos and notes are added to the workflow to help monitor the lead and to ensure that no action is missed through inadvertence. A system user may add a to-do or note to the lead's workflow or mark the to-do as completed. In some embodiments, the system may generate to-dos automatically in response to an event. For example, if a patient does not show up for an appointment or a procedure (fails to check into the system), the system may generate a to-do for a sales consultant, administrator, or healthcare provider to follow-up with the patient to determine the cause. In another embodiment, the system may interface with a calendar and check-in module (not depicted) that tracks patients appointments in real-time. When the patient checks-in for an appointment, the system adds an item to the patient's workflow to indicate that the appointment was kept. Or, if the patient fails to show up for the appointment, the system may add an item to the patient's workflow indicating that the patient did not appear as scheduled. FIG. 13 depicts an administrative interface that displays a patient's ID#, name, age, counselor, and current location (if the practice has multiple offices) whenever the patient checks in for his or her appointment. In a particular embodiment, special patients requiring additional attention may be given a different visual style to alert administrators to their arrival. Alternatively, a system message may be generated and transmitted to subscribers via email, text message, instant message, pager, Twitter®, or any suitable notification system. Likewise, when patients are past due for an appointment, an indication will appear in a past due list on the dashboard to alert office staff to contact the patient to offer assistance, such as last minute driving directions.

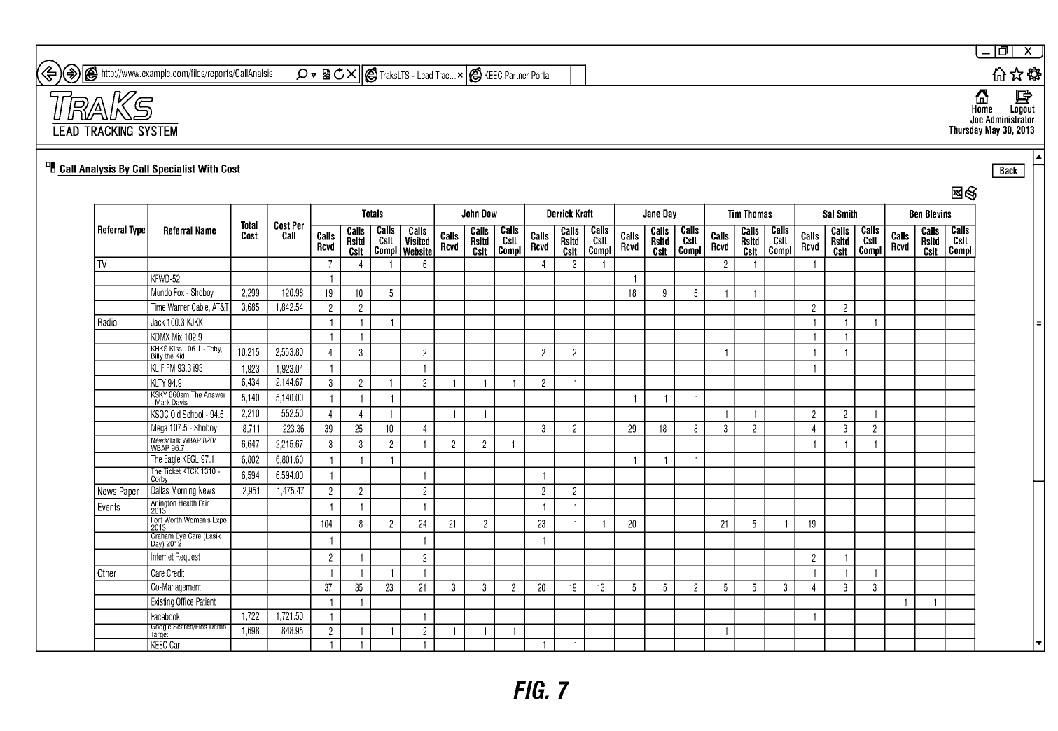

When the lead agrees to receive treatment from the medical practice, the system records which sales consultant was responsible for converting the lead. In step 306, revenues earned from all patients originating from a particular referral channel are summed. The amount invested in the referral channel is also determined. The system then calculates, in step 308, a ratio between the cost of obtaining referrals and the total revenue earned from patients citing that source. FIG. 7 illustrates a report in accordance with one embodiment that details the cost of advertising broken out by referral channel juxtaposed with the total leads received, the leads that resulted in a consultation, the leads that then complete the consultation, and the leads who visited the medical practice's website. The totals for the leads are then broken out by individual sales consultant. The report may be printed or exported to a computer readable file format such as a delimited text file, a spreadsheet, an XML dataset, or any similar format for representing structured data. In step 310, the referral sources are ranked according to the ROI ratio to determine the most and least effective sources of new patients.

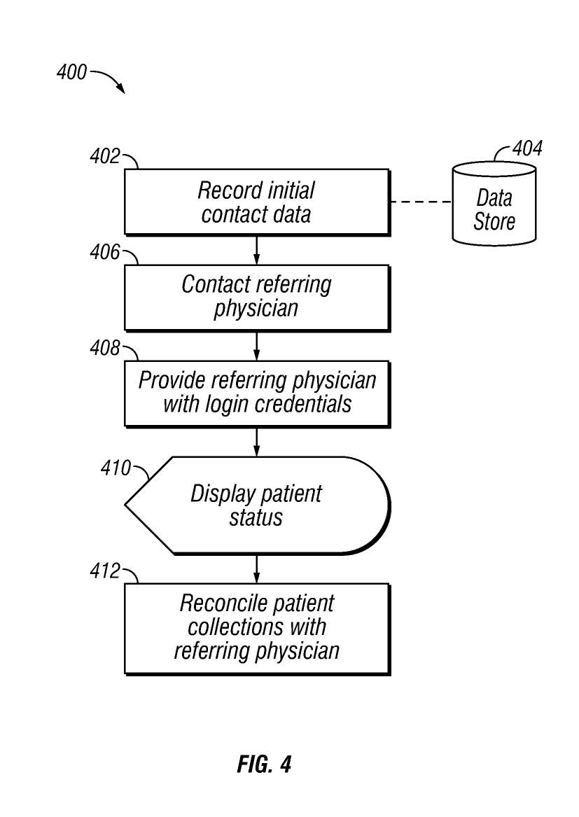

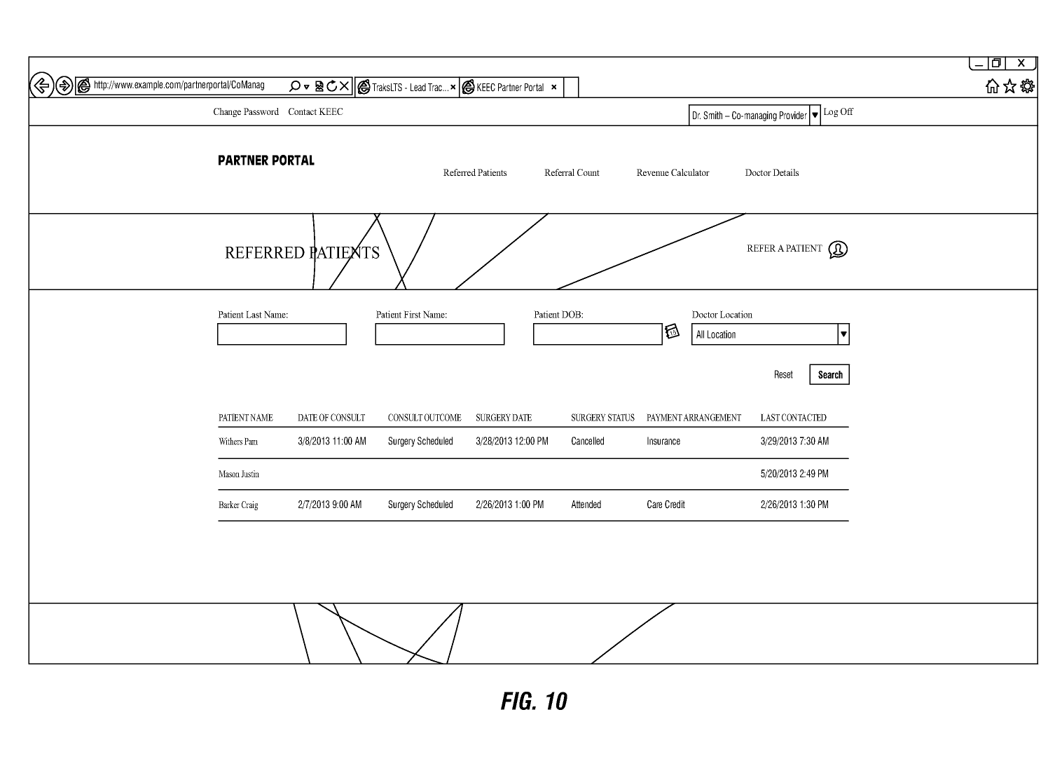

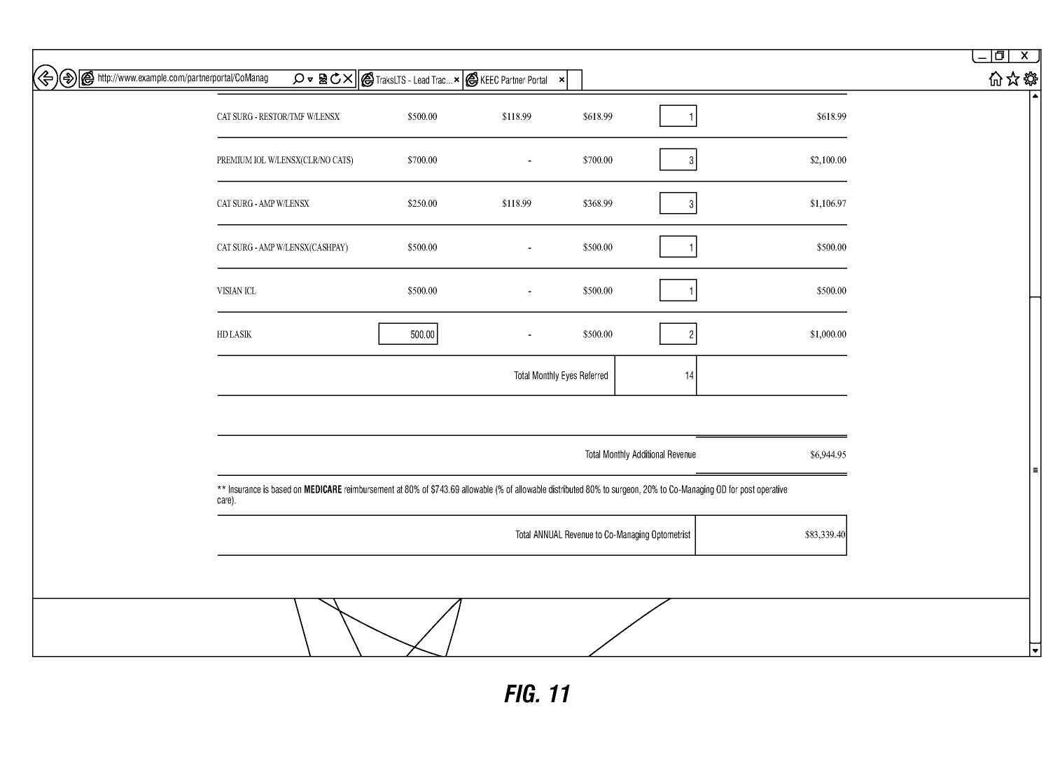

FIG. 4 illustrates a method of co-managing patient care with a referring physician, indicated generally at 400, in accordance with another embodiment. In step 402, the patient's contact data is collected and persisted in a data store 404. The data store 404 may be implemented using any device or service operable to store and retrieve structured data, such as non-volatile flash memory, a hard disk, a flat file, a database, a network file system, network attached storage, a distributed file system, cloud storage, or a web service. Contact is made with the referring healthcare provider 406. In one embodiment, co-management of the patient may be facilitated by providing a partnership portal through which to share selected patient information. The referring physician is provided with login credentials in step 408. FIG. 10 illustrates a web-based interface in accordance with one such embodiment that displays to logged-in providers patient information such as consultation date and outcome, procedure date and status, payment arrangement, and date of last contact in step 410. Other patient information, such as any of the fields depicted in FIGS. 6, 9, and 14, may be selected and shared through the partnership portal. In step 412, the system reconciles earned fees, or patient revenue, with the co-managing provider based on the service performed by the co-managing provider. Fees may be collected directly from the patient or indirectly from a third party for the benefit of the patient. For example, the system may assign a fixed fee or a pro rata portion of the total fees earned from a patient to a co-managing provider who provided the patient with pre- and post-operative care. Alternatively, the system may generate or cause to be generated information necessary for the co-managing provider to bill the patient's insurance. In a particular embodiment, a referral reward estimation tool may be provided to project weekly, monthly, or annual revenue to a co-managing health services provider as illustrated in FIG. 11. A user may view the referral reward amounts offered for certain co-managed care services and input an estimate of the number of patients referred for such treatment.

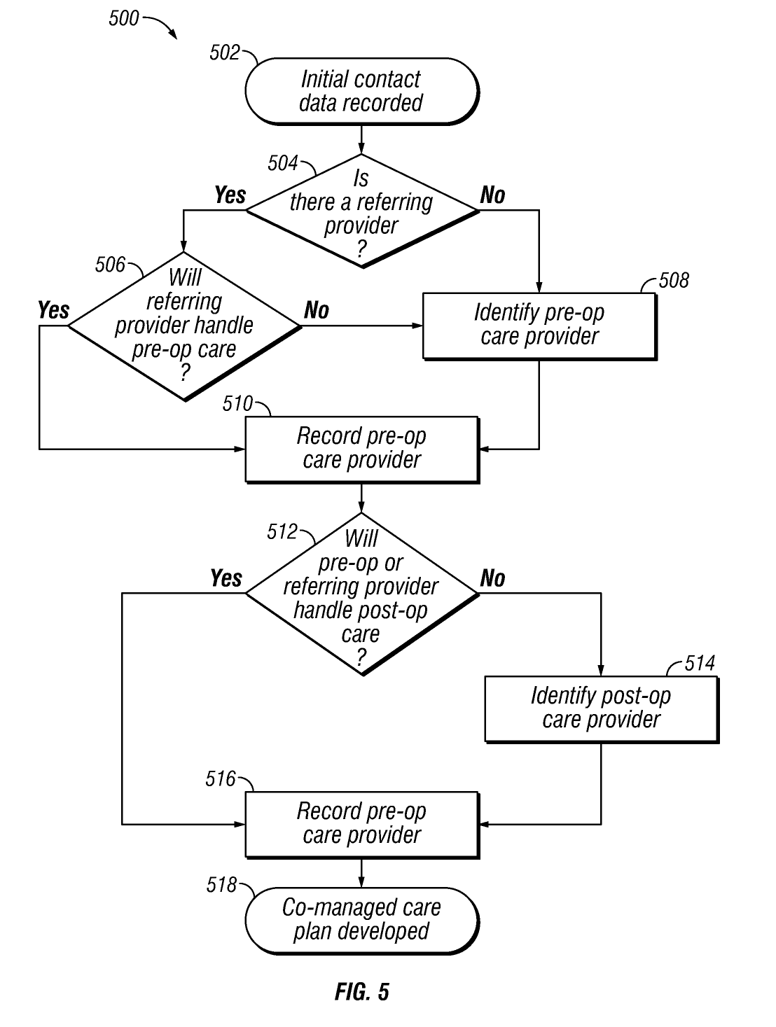

FIG. 5 illustrates a method of developing a co-managed care plan, indicated generally at 500, in accordance with another embodiment. Initial contact data for a patient is recorded in step 502. At step 504, the system determines whether there is a referring healthcare services provider. If there is a referring healthcare services provider, the system determines in step 506 whether the provider will handle pre-operative treatment or care. If there is no referring healthcare services provider or if the referring provider will not handle pre-operative treatment or care, a provider of pre-operative is identified in step 508. Once a provider of pre-operative treatment or care is identified, the provider associated with the patient is recorded by the system in step 510. At step 512, the system determines whether the any providers of healthcare services associated with the patient are assigned to offer post-operative care. If none are assigned, the system identifies a post-operative care provider in step 514 and records the assignment in step 516. The development of a co-managed care plan concludes at step 518.

The invention may be embodied in other specific forms without departing from the spirit or essential characteristics thereof. The present embodiments are therefore to be considered in all respects as illustrative and not restrictive. Accordingly, the scope of the invention is established by the appended claims rather than by the foregoing description. All changes which come within the meaning and range of equivalency of the claims are therefore intended to be embraced therein. Further, the recitation of method steps does not denote a particular sequence for execution of the steps. Such method steps may therefore be performed in a sequence other than that recited unless the particular claim expressly states otherwise.

We claim:

1. A method of co-managing patient care, comprising the steps of:
offering a first healthcare service to treat a patient condition;
identifying a second healthcare service required by the first healthcare service;
storing in a memory a plurality of co-managing providers that are qualified to offer the second healthcare service; and
querying the memory to identifying a plurality of co-managing providers based on search criteria including an address of the patient.

2. The method of claim 1, wherein:
the search criteria include a maximum distance between a preferred location of the patient and a co-managing provider.

3. The method of claim 1, wherein:
the search criteria include the type of insurance accepted by a co-managing provider.

4. The method of claim 1, further comprising the steps of:
referring the patient to a co-managing provider selected from the plurality of co-managing providers.

5. The method of claim 1, further comprising the steps of:
ranking the plurality of co-managing providers according to a score.

6. The method of claim 5, further comprising the steps of:
the score is determined in part by the number of referrals made to a co-managing provider during a fixed period.

7. The method of claim 5, wherein:
the score is determined in part by whether the co-managing provider is in network.

8. A method of improving patient access to care, comprising the steps of:
obtaining a lead that was exposed to at least one message through a referral channel;
identifying the referral channel the lead was obtained through; and
tracking the lead to determine if the lead becomes a patient.

9. The method of claim 8, wherein tracking the lead comprises:
storing in the memory a record of at least one communication with the patient.

10. The method of claim 8, wherein tracking the lead comprises:
identifying a sales consultant who converts the lead into a patient.

11. The method of claim 10, further comprising the steps:
displaying to the sales consultant in real-time the commission earned by converting the lead into a patient.

12. The method of claim 10, further comprising the steps:
determining a first value by counting the number of leads obtained through a referral channel;
determining a second value by counting the number of leads obtained through the referral channel that the sales consultant converted into patients;
calculating a conversion ratio for the sales consultant by dividing the second value by the first; and
evaluating the sales consultant's performance by comparing the conversion ratio to another sales consultant's conversion ratio.

13. The method of claim 8, wherein the referral channel comprises radio advertising.

14. The method of claim 8, wherein the referral channel comprises web-based advertising.

15. The method of claim 8, wherein the referral channel is a co-managing provider.

16. The method of claim 15, further comprising the steps:
splitting a fee with the co-managing provider based on the service performed by the co-managing provider, the fee having been incurred by the patient.

17. The method of claim 8, further comprising the steps:
establishing a relationship with a co-managing provider by referring a patient to a co-managing provider to have a healthcare service performed.

18. The method of claim 17, further comprising the steps:
providing a portal through which selected patient information may be shared with the co-managing provider.

19. The method of claim 8, further comprising the steps:
determining a first value by summing the amount earned from patients converted from leads exposed to a referral channel;
determining a second value by summing the amount spent obtaining the leads exposed to the referral channel;
calculating a rate of return by dividing the first value by the second value; and
adjusting future investment in the referral channel based on the rate of return.

20. The method of claim 8, further comprising the steps:
automatically assigning the lead to a sales consultant; and
generating a plurality of to-dos for the sales consultant to plan communication with the lead.
